(19) United States
(12) Patent Application Publication
(10) Pub. No.: US 2016/0330549 A1
(43) Pub. Date: Nov. 10, 2016

(54) Speaker Diaphragms and Speakers with the Same

(71) Applicant: Innovation Sound Technology Co., Ltd, Shenzhen, Guangdong (CN)

(72) Inventor: Shun Ming YUEN, Hong Kong (CN)

(21) Appl. No.: 15/109,532

(22) PCT Filed: Jan. 7, 2014
(86) PCT No.: PCT/CN2014/070229

§ 371 Date: Jul. 1, 2016

(51) Int. Cl. H04R 7/12; H04R 9/02; H04R 7/14; H04R 9/06

(52) U.S. Cl. CPC H04R 7/125; H04R 9/06; H04R 9/025; H04R 7/14; H04R 2307/025

(57) ABSTRACT

The utility model relates to a type of speaker diaphragm and speakers with the same, the diaphragm is formed of the first polyester film layer, a polyurethane film layer and the second polyester film layer which are laminated sequentially and adhered together. Another technical solution is: a speaker diaphragm, the diaphragm is formed of the first polyester film layer and the second polyester film layer which are laminated and adhered by using the adhesive. In addition to using the speaker diaphragm, the speaker further comprises sequentially assembled voice coil, washer, magnet, U-shaped iron cup, holder, PCB board and sound mixing paper. The speaker diaphragm of the utility model is made of the composite material, which solved the defects that the thin diaphragm of the traditional speaker diaphragm is soft and the damping of the existing polyester thin film material is small Moreover, the surface of the diaphragm is added with stiffeners such that the diaphragm vibration is more balanced after installation, thus obtaining a wider frequency response and more exquisite subjective auditory sense.

### FIELD OF THE INVENTION

The utility model relates to a type of vibration sounding diaphragm for speakers and speakers using the diaphragm.

### BACKGROUND OF THE INVENTION

The existing speaker sounds by the coil pushing the diaphragm under the magnetic field to vibrate and drive the air. In the existing speaker structure, the coil driving the voice diaphragm is arranged on the bottom surface of the ball top of the diaphragm and the vibration of the diaphragm is often offset from the axis in actual use.

However the micro-speaker diaphragm mainly adopts polyester film material, the polyester film material mainly comprising PET, PEEK, PEN, PEI and PAR. The designer always obtains various better acoustic performance parameters by changing the shape of the diaphragm, such as frequency response, total harmonic distortion, FO, subjective auditory feel etc. specifically, the shape design of the diaphragm is mainly the arched shape or the combination of several arched curves. Because the polyester film material is thin and the damping of the material is poor, the existing micro-speaker diaphragm is easy to deform and deviate in general.

### Contents of Utility Model

The utility model mainly aims to solve the technical issue: providing a speaker diaphragm having the better acoustic performance parameter after being applied while solving the diaphragm distortion, and a speaker using the diaphragm.

The utility model offers a technical solution for solving the technical issue: a speaker diaphragm comprises a central ball top and a curved portion connected to the bottom edge of the central ball top, the diaphragm is formed of the first polyester film layer, a polyurethane film layer and the second polyester film layer which are laminated sequentially and adhered together, the first polyester film layer, the polyurethane film layer and the second polyester film layer are the same in shape and size. The utility model offers another technical solution for solving the technical issue: a speaker diaphragm comprises a central ball top and a curved portion connected to the bottom edge of the central ball top, the diaphragm is formed of the first polyester film layer and the second polyester film layer which are laminated and adhered by using the adhesive, the first polyester film layer and the second polyester film layer are the same in shape and size.

Furthermore, the curved portion is provided with a plurality of stiffeners, the plurality of stiffeners are closely arranged by centering around the central ball top to form a rotating divergent ring.

Furthermore, the curved portion consists of multiple continuous arched curved segments.

Furthermore, the first, second polyester film layers are made of PEEK composite film material.

A speaker using the speaker diaphragm, further comprises sequentially assembled voice coil, washer, magnet, U-shaped iron cup, holder, PCB board and sound mixing paper.

The advantages of the utility model are as follows:

The speaker diaphragm of the utility model is formed of the polyester film+polyurethane film+polyester film composite material or the material obtained by adhering double layers of polyester films by adhesive, which solves the defects that the thin diaphragm of the traditional speaker diaphragm is soft and the damping of the existing polyester thin film material is small and is not easy to distort and deviate.

In combination with the characteristic of the new speaker diaphragm composite material, the diaphragm is added with more thinner stiffeners such that the diaphragm vibration is more balanced after installation, thus obtaining a wider frequency response and more exquisite subjective auditory feel.

### BRIEF INTRODUCTION OF THE DRAWINGS

In combination with the drawings, the speaker diaphragm and the speaker of the utility model are further described as follows.

FIG. 1 is the structural schematic view of the speaker diaphragm of the utility model.

FIG. 2 is the top view of the structure in FIG. 1.

FIG. 3 is the layered structural schematic view of the speaker diaphragm in embodiment 1.

FIG. 4 is the layered structural schematic view of the speaker diaphragm in embodiment 2.

FIG. 5 is the cross-section structural schematic view of the speaker of the utility model.

FIG. 6 is the structural exploded view of the speaker diaphragm of the utility model.

### DETAILED DESCRIPTION OF THE PREFERRED EMBODIMENTS

### Embodiment 1

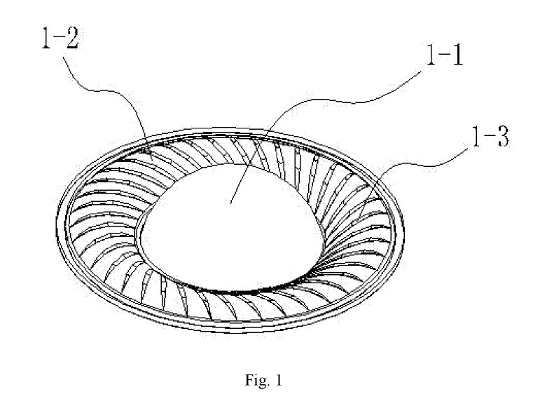

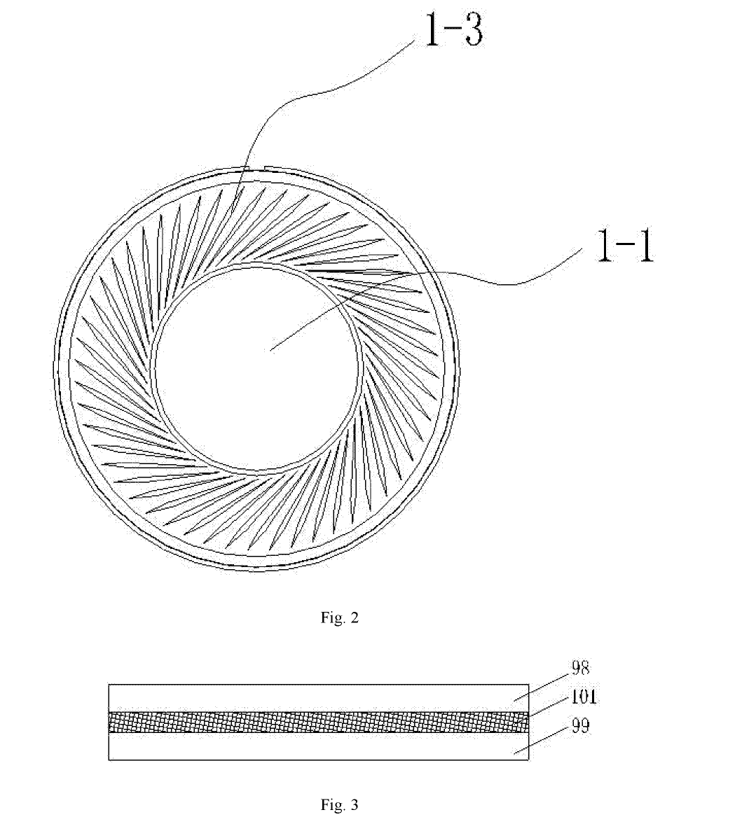

As shown in FIG. 1, FIG. 2, FIG. 3, FIG. 5 and FIG. 6, the speaker diaphragm 1 of the utility model comprises a central ball top 1-1 and a curved portion 1-2 connected WITH the bottom edge of the central ball top 1-1.

The speaker diaphragm 1 is formed of the first polyester film layer 98, a polyurethane film layer 101 and the second polyester film layer 99 which are laminated sequentially and adhered together. The first polyester film layer 98, the polyurethane film layer 101 and the second polyester film layer 99 are the same in shape and size. During adhesion, the traditional adhesive bonding process or high-temperature high-pressure one-time lamination process may be used.

The curved portion 1-2 is provided with a plurality of stiffeners 1-3, the plurality of stiffeners 1-3 are closely arranged by centering on the central ball top 1-1 to form a rotating divergent ring.

The curved portion 1-2 of the utility model is only a one-segment arched structure. It is obvious that curved portion 1-2 can be composed of multiple continuous arched curved segments.

Both the first polyester film layer 98 and second polyester film layer 99 are made of the PEEK (polyether-ether-ketone) composite film material. It is obvious that the first polyester film layer 98 and the second polyester film layer 99 are made of the other polyester film material.

### Embodiment 2

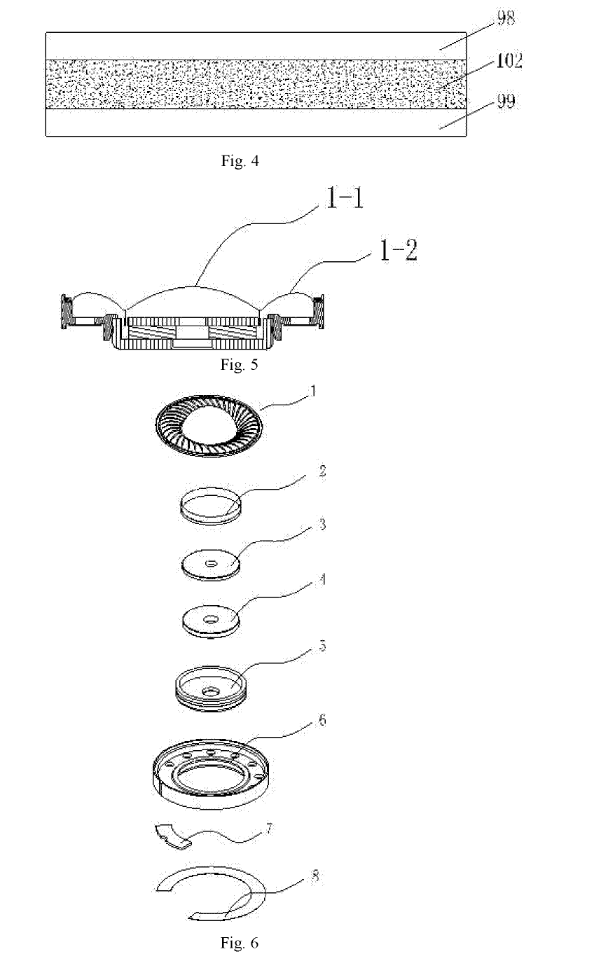

The embodiment carries out a replacement based on embodiment 1, as shown in FIG. 4, the only difference of the embodiment from the technical solution in embodiment 1 is the structure of the speaker diaphragm 1 is different: the speaker diaphragm 1 of the embodiment is formed of the first polyester film layer 98 and the second polyester film layer 99 which are laminated and adhered by using the adhesive. The first polyester film layer 98 and the second polyester film layer 99 are the same in shape and size.

### Embodiment 3

The embodiment is the application of the speaker diaphragm 1 in Embodiment 1. The speaker in the embodiment comprises the speaker diaphragm 1 in embodiment 1, and sequentially assembled voice coil 2, washer 3, magnet 4, U-shaped iron cup 5, holder 6, PCB board 7 and sound mixing paper 8.

The voice coil 2 is connected with the bottom of the speaker diaphragm 1; the washer 3 and the magnet 4 are fixed integrally and further put in the U-shaped iron cup 5 and forms a magnetic gap with the inner wall of the U-shaped iron cup 5; the lower part of the voice coil 2 extends into the magnetic gap; the U-shaped iron cup 5 is connected with the holder 6, the bottom of the holder 6 are respectively provided with controlling and tuning circuit and sound mixing paper 8, the circuit is arranged on the PCB board 7.

### Embodiment 4

The difference of the embodiment from the Embodiment 3 is: the speaker in Embodiment 3 uses the speaker diaphragm 1 in Embodiment 1, and the speaker in the embodiment uses the speaker diaphragm 1 in Embodiment 2.

The utility model is not limited to the embodiments mentioned above, any technical solution using the equivalent replacement is to be embraced within the scope of protection of the utility model.

1. A speaker diaphragm, comprising a central ball top and a curved portion connected to the bottom edge of the central ball top, wherein the diaphragm is formed of the first polyester film layer, a polyurethane film layer and the second polyester film layer which are laminated sequentially and adhered together. The first polyester film layer, the polyurethane film layer and the second polyester film layer are the same in shape and size.

2. A speaker diaphragm, comprising a central ball top and a curved portion connected to the bottom edge of the central ball top, wherein the diaphragm is formed of the first polyester film layer and the second polyester film layer which are laminated and adhered by using the adhesive. The first polyester film layer and the second polyester film layer are the same in shape and size.

3. The speaker diaphragm as claimed in claim 1, wherein the curved portion is provided with a plurality of stiffeners, the plurality of stiffeners are closely arranged by centering around the central ball top to form a rotating divergent ring.

4. The speaker diaphragm as claimed in claim 1, wherein the curved portion consists of multiple continuous arched curved segments.

5. The speaker diaphragm as claimed in claim 1, wherein the first, second polyester films are made of PEEK composite film material.

6. A speaker, using the speaker diaphragm as claimed in claim 1.

7. A speaker, using the speaker diaphragm as claimed in claim 2.

8. The speaker as claimed in claim 6, further comprising sequentially assembled voice coil, washer, magnet, U-shaped iron cup, holder, PCB board and sound mixing paper.

9. The speaker as claimed in claim 7, further comprising sequentially assembled voice coil, washer, magnet, U-shaped iron cup, holder, PCB board and sound mixing paper.

10. The speaker diaphragm as claimed in claim 2, wherein the curved portion is provided with a plurality of stiffeners, the plurality of stiffeners are closely arranged by centering around the central ball top to form a rotating divergent ring.

11. The speaker diaphragm as claimed in claim 2, wherein the curved portion consists of multiple continuous arched curved segments.

12. The speaker diaphragm as claimed in claim 2, wherein the first, second polyester films are made of PEEK composite film material.
